(19) United States
(12) Patent Application Publication
(10) Pub. No.: US 2014/0188531 A1
(43) Pub. Date: Jul. 3, 2014

(54) METHOD AND SYSTEM FOR COST ESTIMATION AND PAYMENT OF THE PRODUCT

(71) Applicant: Krasimir Popov, Sofia (BG)

(72) Inventor: Krasimir Popov, Sofia (BG)

(21) Appl. No.: 14/007,674

(22) PCT Filed: Apr. 10, 2012
(86) PCT No.: PCT/BG2012/000010

§ 371 Date: Sep. 26, 2013

(30) Foreign Application Priority Data
Apr. 11, 2011 (BG) 110910

(51) Int. Cl. G06Q 10/06

(52) U.S. Cl. CPC G06Q 10/0631
USPC 705/7.12

(57) ABSTRACT

A method has been revealed, which is applicable in the execution of tasks, characterized with the presumed use of products from more than one supplier during their realization, cost- setting and payment for electronic content and/or software and/or services, rendered by operators of computer-based systems, functioning in a common environment such as the Internet, cloudy environment, etc. The method provides the opportunity for cost-setting and payment, guaranteeing the free participation of various suppliers.

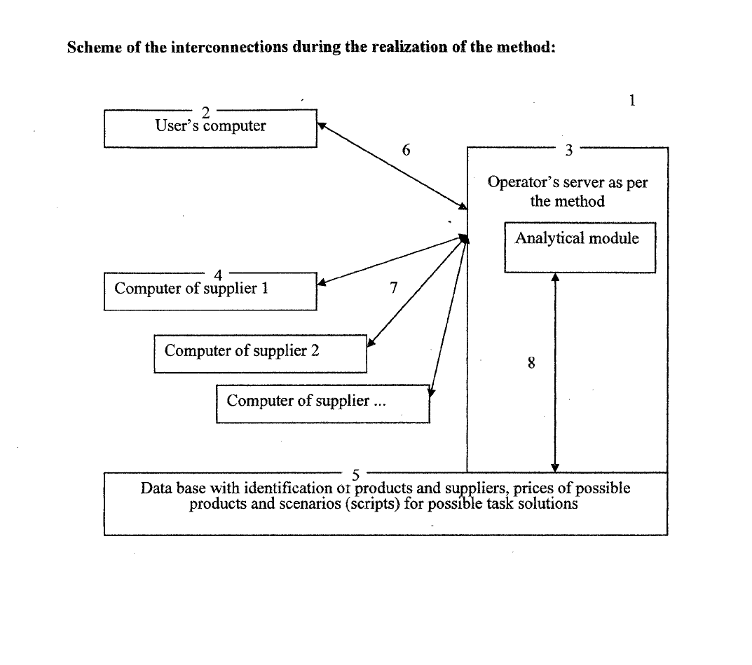

### TECHNICAL FIELD

The present invention relates to a computer-based method for placement of tasks, cost-estimation and payment for used electronic content, services and software, delivered in a common environment like the Internet, cloudy environments etc., by various suppliers when for the realization of tasks is necessary the use of combinations of products from different suppliers.

### BACKGROUND ART

A wide variety of payment methods is in existence for using services at fixed prices in a common environment such as the purchasing of goods from online dealers, subscription for electronic publications, etc. Methods exist for the cost estimation of an advertisement exhibition in the Internet, based on its location and number of visits /clicks/. There is also a method for priority listing of contents, depending on the frequency of the visits and so on.

Common environments exist for the use, purchase and exchange of electronic content and services, like the Internet, cloudy environments, etc. Within the framework of these environments, the users use the electronic content, services and software for which they pay, directly of indirectly, while the suppliers of electronic content, services and software sell their products via a product-based approach, setting their costs in a number of ways and according to their marketing strategy. Payments are made on the principle of “product purchasing”—content or service from a supplier or via indirect payments—positioning of an advertisement banner with the user. The existing methods for cost-estimation and payments for content and services in a common environment create—on the one hand—difficulties for the users in the realization of the tasks they have placed, as its becomes necessary for them to know and pay for a number of different applications, contents and services and on the other, they create difficulties for the suppliers of electronic content, services and software when working for their realization.

There are a number of methods for the standardization of the technical connectivity between separate software modules and program systems. One standard option is, for example, the use of DLL (Dynamic Linked Library) for the rendering of services to independent producers within the Windows environment. The COM objects and Active X controls, which use DLL, are also practically well known. The graph creation system, using multimedia components in Windows, is also well known and its task is the reproduction or processing of multimedia content. One specific feature of this system is that each program, which executes a part of the process like the reading of a file, decoding audio or video streams, rendering on the screen has been described as a block with one or many input points and one or many output points. Each such point is described in terms of the kind of data and format it can accept. The description of the input and output points in many cases permits the automatic generating of a graph, which reproduces the multimedia content.

WEB service descriptors have been developed and implemented using XML, for example, so that the service may be accessed by users who communicate with it only on the interface level.

So far there is no known method which can furnish the suppliers of contents, services and software, rendered in a common environment, with the opportunity to freely add their content and/or service and/or software to already existing such, generating added value without the necessity of entering into negotiations with other suppliers so that a more variable content may be supplied and/or a more complete service within a process of common price setting of the obtained concrete products, conforming to the task placed by the user, which presumes a combination of various products without creating difficulties related to the necessity of having to work with different interfaces and products as well as to pay in separate for each used product.

### SUMMARY OF THE INVENTION

The method is realized via a machine-based common data exchange environment where a number of computer devices have been connected and which gives users the possibility to use it for the resolving of concrete tasks, placed by themselves, while for the suppliers of the services, electronic content, applications and software to add their products freely, thus transforming them into a part of the process of task solving and to define their value in advance or to accept an approach for cost setting, announced in advance by the operator¹ of the environment as per the adopted method. ¹ Operator of the environment—for the aims of the invention has the meaning of the supplier of the service created according the method in his role of integrator of the steps applicable to the users and to the suppliers in the common computer based environment for data exchange.

The method consists of the following stages:
Suppliers of electronic content and/or software and/or services address, via a computer device which is a part of the common data exchange environment connecting a number of such devices, to a server run by an operator of the environment as per the method, in order to deliver their products for use. The suppliers have set the cost of the products use for these purposes in advance or have adopted an approach for cost-setting, announced previously by the operator of the environment.
In a computer device, which is a part of the same environment, an entry is made in a machine-readable data base with identification of the products and the suppliers, the values of the possible products and scenarios (scripts) for the possible solution of tasks, which may be executed via combinations of electronic content and/or software and/or services rendered by the various suppliers.
Via a computer device—part of the common environment—the user addresses the operator of the environment for placing a concrete task.
The operator of the environment executes an automatic analysis, as per the criteria set by the user, in the data base with an identification of the products and the suppliers, values of the possible products and scenarios (scripts) for possible solutions, executable through the implementation of steps and using electronic content and/or software and/or services rendered by various suppliers.
In case of possible realization of the task from the operator of the environment, the user receives a message for the cost of the execution of the task as an aggregate of the separate costs of each step, related to the realization of a concrete product. In case there appear to be alternative scenarios for this execution, they are presented in the message with their individual values.
The user selects the scenario for the execution of the task or simply confirms the proposal, if it is only one, and the task then is realized.
Each supplier automatically receives the value of his products, which have been used, in conformity to the methods existing on the current technological level.

After effecting the payment, the user receives a primary accounting document from the operator of the common environment or from each of the suppliers if such a practice has been adopted.

An application of the method is also possible, where instead of paying the price, set by the supplier, the last may exhibit an advertisement space with the user when obtaining a service and/or electronic content and/or software.

An application of the method is also possible, where the suppliers do not set the price of the rendered electronic content and/or software and/or service themselves but receive a proportional part of the fixed price for accessing the computer-based system, in which they participate, in conformity to the frequency of use by users of the product they are supplying.

An application of the method is also possible, where the suppliers do not set the price of the rendered electronic content and/or software and/or service themselves but receive a proportional part of the price for advertisement exposition in the computer-based system where participate, according the frequency of use of the product supplied by the users.

Other application of the method, which may be applied, is where the operator of the environment grants the user with the opportunity to use a unified interface, subject to adaptation to the user's concrete needs. In the process of executing the tasks, placed by the user, the operator acts, through his own computer device automatically, as a virtual agent of the user and after obtaining confirmation uses, on his behalf and at his expense, the products and/or resources in the common computer-based environment showing the results in the unified interface.

It is also possible that the method is realized via the creation of a system for task placing, cost-setting and payment with the use of electronic content and/or services and/or software in a common, computer-based electronic environment.

### DESCRIPTION OF THE ATTACHED FIGURES

A scheme of the interconnections during the realization of the method has been attached:

1. A common, computer based data exchange environment, consisting of a number of interconnected computer devices.

2. User's computer device as a part of the common environment.

3. Operator's environment server as per the method and as a part of the common environment.

4. Suppliers' computer device, part of the common environment.

5. Data base with identification of products and suppliers, prices of the possible products and scenarios (scripts) for possible task solutions.

6. Two-way data exchange between the computer device of user 2 and the server of the operator of the environment 3—placing the task of user 2 and return to operator 3 of the possible executive scenarios after an analysis of the information available in the data base 5, confirmation of a scenario from user 2, payment of the cost and receiving a primary accounting document, if applicable.

7. Two-way data exchange between the computer device of supplier 4 and the server of the operator of the environment 3—supplying products for use by supplier 4; when including a product for the execution of a concrete task—addressing supplier 4 for its realization, the realization of the product to the benefit of user 2 and payment of the cost to supplier 4.

8. Two-way data exchange between the server of the operator of the environment 3 and the data base—when receiving an order for the inclusion of a product on the part of supplier 4 with operator 3—record in the data base of the product identification and supplier, value of the products and scenarios (scripts) for its possible inclusion in task solutions, using data from data base 5 for analysis by the operator 3 and a selection of a suitable scenario for a task, placed by user 2, etc.

### EXAMPLES FOR IMPLEMENTATION

It is possible to create, or to use already created, descriptors of software- modules and WEB services which permit the automatic generation or the manual creation of a graph for their connection so that they may be able to resolve a certain commissioned task. It is also possible, that in addition to the massively used GUID for the identification of the modules, their description to be supplemented with a number of classifiers from a unified nomenclature, which can simplify the search for software modules which solve the task. The descriptors may be supplemented with characteristics, like the frequency of use and likes counter, which will serve to ease the selection. The addition of some characteristics is mandatory: price for the use (this may be zero in the case of a free license), terms of payment, personal identification (private or corporate) to the benefit of whom the payment is to be effected. One may also add characteristics such as period of payment or some other contractual condition for the execution of the payment, like the amount of a minimum sum for effecting the transaction, license conditions related to the duration of use, number of queries, etc.

Via the application of an algorithm, from the base of classified software modules and services one may select the suitable modules and services for the solution of the task placed by the customer or via a WEB-based interface one may also supply the customer with the opportunity to compose the solution to the problem him/herself. In addition to this, the description of the input and output points of the modules and the services may be used “as is” on the level of the technique for establishing the compatibility of the connection. One can also establish the applicability of the license conditions of the supplier to the requirements of the customer. A calculation is made for presentation to the customer. Upon effected payment on the part of the customer, license certificates are issued for the used modules and sums for payment are ordered to the suppliers according to their prices and applicable commercial conditions.

### Example 1

The method may be used for the creation and maintenance of machine-based systems for the searching of an electronic content based on meaning. In order to motivate the suppliers of electronic content to create such content, the operator of the search system can employ the method giving suppliers the opportunity to present it for use by defining its price. Depending on the frequency of use of the various parts of the electronic content, the users pay its price as per the method, while its suppliers will have the opportunity to receive automatic payment for each use or the right to an advertisement space at the location of the user.

### Example 2

The method may be used in the creation and maintenance of machine-based intelligent systems for the execution of complex tasks placed by consumers. In such cases, the intelligent system functions as a virtual agent for the customer, selecting from the data base with possible solutions of tasks, these which can be executed via a sequence of steps, including the use of electronic content and/or applications and/or software and/or services conforming to the customer's needed solution and the respective sequence of steps. For example, the organizing of a holiday: the solution may include the use of electronic content for advertising the possible destinations, the flight booking, hotels accommodation and other tourist services. After obtaining the approval from the user of the selected scenario and payment of the total cost to the operator of the intelligent system, the last proceeds to automatically distribution of the paid sum to each of the employed suppliers according to their individually set prices.

### Example 3

The method may be used for the realization of tasks in a cloudy environment, where the user does not need to know the functions of the separate applications and software products in the cloud. The users may place a task, for example like: encrypt with set parameters and archive with set parameters a given volume of data. The operator of the cloudy environment will act as a virtual agent for the user; he will select the most appropriate encrypting and archiving software from amongst a number of such being made available, according to the parameters defined by the user; he will offer them for approval from the user and after confirmation will encrypt and archive the data. The payment to the operator will then be effected and on his part, the last will automatically pay to the suppliers for their services, the use of software and space for the archive.

### Example 4

The method may also be realized when placing and executing tasks in systems which presume virtual exchange of costs. In this case, the users will pay the available virtual cost as per the method to the virtual account of the supplier and the suppliers can transfer this value to third parties in the form of for example—obtaining the right to an advertisement space with them and/or acquiring the right to use the electronic content and/or services and/or software supplied by third parties which—on its part—can be seconded to end users in the common computer-based environment. In some applications, the users may purchase virtual value as per the methods on the existing technological level.

The above-shown examples are given to illustrate only a few of the possible applications of the method and they are far from exhausting the subject matter.

### APPLICATION OF THE INVENTION

The described method is applicable in the realization of tasks, characterized with a presumed use of products from more than one supplier during their realization, cost-setting and payment for an electronic content and/or software and/or services, delivered via operators of computer-based systems, functioning in a common environment such as the Internet, cloudy environment, etc. The method offers the opportunity for cost-setting and payment, guaranteeing the free participation of a variety of suppliers.

1. A computer implemented method for execution of tasks, placed by users, characterized with the presumed use of the products of more than one supplier in the course of their realization, cost setting, payment and providing the possibility for free trade with electronic content and/or software and/or services within a common, computer-based environment and which consists of the following steps:
suppliers of electronic content and/or software and/or services address, via a computer device, which is a part of a common environment for data exchange connecting a number of computer devices, a server ran by the operator of the environment as per the method in order to deliver their products for use. The suppliers have the cost of products use for such purposes in advance set or have adopted a cost-setting approach which has been previously announced by the operator of the environment;
in a computer device, as a part of the same environment, a record is made into a machine-readable data base with an identification of the products and suppliers, prices of possible products and scenarios (scripts) for the possible solutions of tasks, executable via combinations of electronic content and/or software and/or services, delivered by different suppliers;
through a computer device, as a part of the common environment, the user addresses the operator of the environment in order to place a concrete task;
the operator of the environment performs and automatic analysis, conforming to the criteria, specified by the user, in the data base with an identification of the products and suppliers, prices of the possible products and scenarios (scripts) for the possible solutions of tasks, executable via an application of steps using electronic content and/or software and/or services, delivered by different suppliers;
in case the task can be executed, the user receives, on his/her computer device from the operator of the environment, a message containing the cost for the execution of the task as an aggregate of the separate prices for each used resource connected to the realization of a concrete result. In case of any alternative execution scenarios, they are presented in the message with their individual costs;
the user selects the scenario for the execution of the task or simply confirms the proposed, if the scenario is only one, and the task is realized.
each supplier automatically receives the price for his/her products used in conformity to the methods, existing on the current technological level.

2. Method according to claim 1 where the part of the entry for each product in the machine-readable data base includes:
a label, containing a digit and/or symbol and/or sequence of digits and/or symbols;
a description of the basic characteristics of the product, if applicable;
instructions for product use, if applicable;
a cost for using the product, if applicable;
a data on the supplier, including the account of the supplier, if applicable.

3. Method according to claim 1 where:
the operator of the environment delivers to the user a WEB interface, through which the last may select a solution from among a number of solutions, to change an automatically generated solution or to compose a completely new solution of his/her own with the available modules and WEB services;
via the WEB interface of the operator of the environment, the user orders the sequence and manner for the using of the software modules or services and the task is then executed.

4. Method according to claim 1 where after paying for the use of an electronic content and/or service and or software, and if the approach to the cost setting process presumes so, the user receives a primary accounting document from the operator of the common environment or from each one of the suppliers.

5. Method according to claim 1 where instead of a payment of the cost, set together with the supplier, the operator of the environment gives the supplier the opportunity to use an advertisement space with the rendering of a service and/or electronic content and/or software with the user.

6. Method according to claim 1 where instead of a payment of the cost, set together with the supplier, the operator of the environment gives third parties the opportunity to use advertisement space when providing a service and/or electronic content and/or software at the users location and the price for the used advertisement space or a part of that price is paid to the supplier.

7. Method according to claim 1 where the operator of the environment gives suppliers the opportunity to receive a proportional part of the fixed price for accessing the computer-based environment, in which they participate according to the frequency of use by the users of the product they have supplied.

8. Method according to claim 1 where the operator of the environment gives suppliers the opportunity to receive a proportional part of the revenues from the advertisement exhibit at the users in the computer based environment in which they participate depending on the frequency of use by the users of the product they have supplied.

9. Method according to claim 1 where the operator of the environment gives the user the opportunity to use an unified interface, subject to adaptation according to his/her concrete needs where in the course of executing the tasks placed by the user, the operator acts via his own computer device, as a part of the environment, automatically and as a virtual agent for the user addressing the data base with an identification of the products and the suppliers, prices of the possible products and scenarios (scripts) for the possible solutions of tasks and after making a selection, on the part of the user, he uses in his name and at his/her expense the resources in the common, computer-based environment and shows the results in the unified interface.

10. Method according to claim 1 where the operator of the environment gives suppliers the opportunity to use a unified interface, offering the opportunity for adding services and/or electronic content and/or software and for generating an automatic entry in the data base with products and suppliers identification, the prices of the possible products and scenarios (scripts) for the possible task solutions.

11. A system for an execution of tasks, placed by the user, characterized with a presumed use of the products of more than one supplier in the process of their realization, cost setting and payment with the use of electronic content and/or services and/or software in a common computer-based electronic environment, consisting of:
a unified interface for the placing of tasks and receiving the user's solutions, realized via a computer device as a part of the environment;
a unified interface, realized via a computer device as a part of the environment, giving the opportunity for an automatic addition of services and/or electronic content and/or software from suppliers and for generating of an automatic record in a data base of a machine-readable memory with identification of products and suppliers, prices of the possible products and scenarios (scripts) for possible task solutions;
a data base in a machine-readable memory of a computer device, part of the environment, with scenarios (scripts) for the possible solutions of tasks, product and supplier identification and the prices of the possible products;
an analytical and self-educating module for selecting suitable solutions of concrete tasks, as per the individual needs of the users, from the data base with scenarios (scripts) for the possible solutions of tasks, products and suppliers identification and prices of the possible products.

12. Method according to claim 11, where a part of the system is also
a data base in a machine readable memory in a computer device, as a part of the environment, containing accounts and/or their supplier's virtual equivalent, accounts and/or their user's virtual equivalent and accounting data;
a module for the effecting of a transaction of values after the use of services and/or electronic content and/or software from users to suppliers.

13. Method according to claim 1, where the user places tasks and receives their solutions via a mobile communication device, connected in a network.

14. Method according to claim 1, where the user places tasks and receives their solutions via short text messages (SMS).

15. Method according to claim 1, where the claims are realized via software.
